(19) United States
(12) Patent Application Publication
(10) Pub. No.: US 2008/0050622 A1
(43) Pub. Date: Feb. 28, 2008

(54) Hydrogen elevator

(76) Inventor: Daren K. French, Irvine, CA (US)

Correspondence Address: Daren French, 58 Meadow Valley, Irvine, CA, 92602, US

(21) Appl. No.: 11/511,385

(22) Filed: Aug. 28, 2006

(51) Int. Cl. H01M 8/06; H01M 8/18

(52) U.S. Cl. 429/17; 429/21

(57) ABSTRACT

A system used to generate energy by utilizing the effects of gravity on the lighter “supplied molecules” and the heavier “produced modules” in relation to the air pressure and gravity surrounding the system. While there are many applications to this concept, the example provided utilizes the electrolysis of distilled water (H₂O) into hydrogen and oxygen molecules. The hydrogen molecules are allowed to rise (due to their relatively lighter composition) up to a water vapor extractor component which is situated above (relative to the earths gravity) the electrolyser and/or source of the hydrogen modules. Once the hydrogen reaches the water vapor extractor component it is recombined with oxygen (another light molecule) to produce electricity, heat, and water vapor (a heavier molecule produced by the combination of the two lighter molecules). The water vapor (or heavier byproduct) is then condensed to the point that gravity begins to accelerate the water modules downward towards the earth. Micro-generators are then placed within the path of the downward accelerating water molecules in order to capture the energy produced by the gravitational forces.

### BACKGROUND

The process known as electrolysis has been around since 1805 when first presented by Theodor Grotthuss. When Grotthuss began developing his views on electrolysis he had not thoroughly reviewed all the literature that others had published on this topic. That made him less bound to the scientific dogmas of others. Grotthuss created his theory starting from scratch and basing himself on what he found out himself. This is similar to the approach I used when developing this present invention. With little scientific training, I have used the knowledge obtained from personal reading and exploration to derive this present invention.

The basis for this present invention was tested using the conventional electrolysis of water into hydrogen and oxygen, two relatively lighter than air gases. Water electrolysis occurs when electricity flows between two electrodes which are immersed in an electrolyte.

The method of electrolysis used in my testing involved the use of solid electrolyte membranes, in this case a polymer electrolyte membrane which uses a thin membrane made of Nafion. The cathode is a carbon structure coated with platinum; the anode also a carbon structure made with ruthenium and iridium. When immersed in deionized water with an electrical charge added to the membrane the anode produces oxygen, while the cathode produces hydrogen. (e+H₂O═H₂+O)

Steam electrolysis has been shown to have greater efficiencies so that method may be used in the future to obtain greater system efficiency.

By producing these gases and running a long tube up to a proton exchange membrane fuel cell (PEMFC), which was positioned above the electrolyser (relative to the earth), I was able to determine that hydrogen would rise up to the fuel cell with little effort and recombine with oxygen (abundant in the surrounding air) to produce energy in the forms of electricity and heat, as well as the by product of water vapor.

The heavier element (water vapor) created by the combination of the hydrogen and oxygen could then be condensed to the point at which gravity would cause it to accelerate downward. The energy created by this downward acceleration could then be converted in to additional electrical energy by use of small micro-hydro generators positioned in the path of the accelerating water.

Through further experimentation I have determined that other methods for extracting the water vapor from the produced hydrogen are more efficient. These other methods, including high efficiency combustion engines (using hydrogen as their combustion fuel) are more efficient at producing water vapor while still generating the same amount of initial energy as a fuel cell, and are thus more applicable to creating a higher potential for additional energy in the process described herein.

Once produced through the water vapor extractor component, the water is then allowed to accelerate downward at various angles and when many (perhaps hundreds or thousands) of micro-hydro generators are placed within the path of the water, a large amount of electricity can be generated depending on the run length, the number of generators, the efficiency of each generator, and the volume of water produced by various modifications made to the water vapor extractor component.

### SUMMARY

The present invention seeks to provide a novel method for producing electricity by combining two relatively light elements (generally lighter than air gases) into a heavier element (generally a liquid) and then allowing that element to be accelerated toward the earth through gravitational forces. As the heavier element accelerates, some of the energy is turned into electricity by micro-generators placed in the path of the moving element.

The potential for very large amounts of electrical generation is possible depending on the overall size and length of the system.

The initial proposed enclosed system using this invention would involve using a PEM electrolyser which converts water into hydrogen and oxygen. The hydrogen would be fed to a water vapor extractor component located above (relative to the earths gravity) the electrolyser which would combine the hydrogen with oxygen (either fed from the electrolyser or directly from the available air), to produce electricity, heat, and water vapor.

The heat would be used to generate additional electricity and assist with the condensation of the water vapor. The condensed water vapor would then be allowed to flow through a downward sloping piping system. Within this system would be a large number of micro-hydro generators which would each produce a small amount of electricity. When added together the amount of electricity could be substantial given a long enough piping system back to the electrolyser.

### DESCRIPTION OF DRAWINGS

The present invention can be understood and better appreciated from the following detailed description, taken in conjunction with the following drawing:

FIG. 1—A pictorial illustration depicting an example of how the present invention could be used in a real world deployment.

### DETAILED DESCRIPTION OF PREFERRED EMBODIMENTS

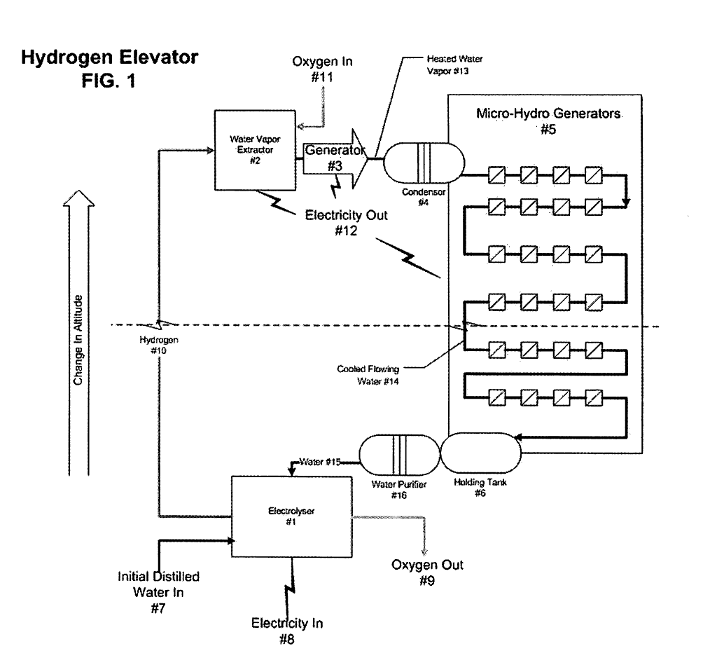

Reference is now made to FIG. 1 that provides a depiction of a potential real-world deployment of the present invention. This diagram consists of an electrolyser 1 which takes in distilled water 7, and electricity 8 and produces oxygen 9 and hydrogen 10. The oxygen is not used in the process; however the hydrogen 10 is fed into the water vapor condenser component 2 where is it combined with oxygen 11 from the air to produce electricity 12 and heated water vapor 13. The heated vapor 13 is pushed through a turbine 3 which produces additional electricity 12 and is then sent into a condenser 4 where it changes into a liquid form and is allowed to flow through piping to various micro-hydro generators 5 which produce additional electricity 12. Upon completion of its drop through the micro-hydro generators and into a holding tank 6, and then into a purification system 16, and finally the water 15 is then fed back into the electrolyser for reuse.

Some additional steps have been intentionally left out to simplify the diagram; however the depiction demonstrates the functionality of the present invention.

1. A method for obtaining energy from the downward acceleration of liquid (generally H₂O, but H₂O is not a required component of this invention) produced through electrolysis, where the water vapor extractor component is placed above (relative to the earths gavity) the electrolyser thus allowing the lighter molecules produced by the electrolyser to rise to the fuel cell which combines those lighter molecules with other lighter molecules to produce energy in the form of electricity, heat, and a heavier liquid gas component. The liquid gas component is further condensed to produce a heavier liquid component that is attracted by gravity to such a degree that the liquid begins to accelerate back toward the earth. As the liquid is accelerated toward the earth, micro-generators are placed in its path to capture the energy produce by the gravitation forces and thus generate additional electricity.

2. The method of claim 1, wherein the liquid supplied to the electrolyser in our examples is distilled H₂O, but various other liquids may be used as long as the gas produced by the electrolysis process can ascend to the fuel cell above (relative to the earth) the electrolyser.

3. The method of claim 1, wherein the electrolyser in our examples is a PEM or polymer electrolyte membrane is used to separate the distilled H₂O into hydrogen and oxygen components when electricity is applied. However various other electrolysis methods may be used as long as the resulting components include a lighter molecule which can be recombined with another molecule to produce a heavier molecule which is pulled downward by gravitational forces.

4. The method of claim 3, wherein the lighter gas (in our examples is hydrogen) is produced by a electrolyser, other lighter gases may be produced using different methods as long as lighter gas is combined with other modules above (relative to the earth) the source of the lighter gas molecules which under such combination produce energy in the forms of electricity, heat, and a byproduct which is heavier than the lighter gas and is condensed to the point in which gravity will effect the heavier substance and cause it to accelerate downward towards the earth.

5. The method of claim 1, wherein the water vapor extractor component (in our example is a high efficiency combustion engine) is used to combine the lighter gas with other molecules to produce heavier modules (in our example H₂O) which when properly condensed are then effected by gravity in such a way as to cause those molecules to accelerate downward toward the earth.
